(19) United States
(12) Patent Application Publication
(10) Pub. No.: US 2023/0155320 A1
(43) Pub. Date: May 18, 2023

(54) ELECTRICAL CONDUCTOR FOR CONDUCTING ELECTRICAL CURRENT THROUGH A HOUSING AND METHOD FOR MANUFACTURING THE SAME

(71) Applicant: BRUSS SEALING SYSTEMS GMBH, HOISDORF (DE)

(72) Inventors: JÜRGEN GRUNDT, NEUMÜNSTER (DE); RALF PIELKE, SEEVETAL (DE); NINA VON PRONDZINSKI, HAMBURG (DE); MANFRED BRAND, TREMSBÜTTEL (DE)

(21) Appl. No.: 17/988,293

(22) Filed: Nov. 16, 2022

(30) Foreign Application Priority Data
Nov. 16, 2021 (DE) 10 2021 129 840.7

(51) Int. Cl. H01R 13/52

(52) U.S. Cl. CPC H01R 13/5216; H01R 13/5205; H01R 2201/10

(57) ABSTRACT

The invention relates to an electrical conductor for conducting electrical current through a housing, wherein a sealing body made of an elastic material is arranged on the electrical conductor, wherein the sealing body encloses the electrical conductor in a first sealing section radially surrounding the electrical conductor, wherein a housing part is arranged on the electrical conductor. The housing part radially encloses at least part of the surface of the sealing body, which is not in contact with the electrical conductor in the first sealing section, in a second sealing section, wherein the elastic material of the sealing body comprises at least one hollow chamber and/or is an elastomer foam. The invention further relates to a corresponding method for manufacturing.

### CROSS-REFERENCE TO RELATED APPLICATION

This application claims priority to German Patent Application No. 10 2021 129 840.7, filed on Nov. 16, 2021; which is incorporated in its entirety herein.

### FIELD OF THE INVENTION

The present invention relates to an electrical conductor for conducting electrical current through a housing and to a corresponding method for manufacturing an electrical conductor for conducting electrical current through a housing.

### BACKGROUND OF THE INVENTION

In electric motors and generators, as a rule, a plurality of electrical conductors or conductor rails are to be fed through a housing wall which separates two spaces, for example a housing of an electric motor and a housing of power electronics or the environment. The conductor feedthrough serves to transmit electrical power between the respective spaces, wherein at the same time the best possible sealing against liquid media, e.g. oil, may be required to prevent oil from penetrating or creeping, for example, up to a power electronics unit. A good seal against gases, e.g. air and/or oil gases, may also be required between the spaces, for example to keep out air humidity.

Known from the prior art for improved sealing are, for example, flow path extensions in the form of ribbing and labyrinth-like structures in the conductor passing through, which is usually made of copper or a copper alloy. The flow path extensions are designed to prevent, or at least significantly impede, oil infiltration between the conductor and a molded-on plastic that forms the housing wall. It has been found that such use of flow path extensions does not provide a sufficient seal against oil and oil gases.

### BRIEF SUMMARY

It is the task of the present invention to provide an electrical conductor with a sealing to a housing part with an improved sealing, in particular against oil and air, and a corresponding method for manufacturing.

The task is solved by the features of the independent claims. To solve the task, an electrical conductor for conducting electrical current through a housing is proposed, wherein a sealing body made of an elastic material is arranged on the electrical conductor, and wherein the sealing body radially encloses the electrical conductor in a first sealing section radially surrounding the electrical conductor, wherein the housing part radially encloses at least part of the surface of the sealing body, which is not in contact with the electrical conductor in the first sealing section, in a second sealing section, wherein the elastic material of the sealing body comprises at least one hollow chamber and/or is an elastomer foam.

### DETAILED DESCRIPTION

The proposed sealing body therefore encloses the electrical conductor by means of the first sealing section and is enclosed by the housing part by means of the second sealing section. At all times, there is contact between the electrical conductor and the sealing body at the first sealing section and between the sealing body and the housing part at the second sealing section. Sufficient sealing pressure is achieved for sealing the electrical conductor against the housing part, in particular against creeping oil. The seal between the housing part and the sealing body is in each case in a closed circuit to prevent leakage.

With the proposed sealing body, detachment of the sealing body at the first and also at the second sealing section can be effectively prevented. The elastic material of the sealing body with at least one hollow chamber and/or in the form of an elastomer foam is compressible due to the gas content or vacuum content thus achieved in the sealing body achieved by this. The proposed sealing body is therefore significantly more compressible in comparison than a solid material, which is elastic but, similar to hydraulic oil or water, very difficult or impossible to compress. The sealing body is therefore preferably pretensioned or compressed between the electrical conductor and the housing part, which ensures sufficient sealing pressure at the first and second sealing sections. In particular, sufficient sealing pressure and tightness can be achieved over a wide temperature range. Since different coefficients of thermal expansion of different materials, for example metal, in particular copper, for the electrical conductor; cross-linked elastomer and/or rubber for the sealing body; and plastic, in particular thermoplastic plastics, for the housing part, can be compensated in this way.

By means of the at least one hollow chamber and/or the elastomer foam, contact breakage and gap formation at the sealing body can be prevented over the entire temperature range. This also applies in particular in the case of uneven temperature distributions, which can occur, for example, during and/or after manufacture. Particularly when high-melting plastics are used for the housing part, the proposed solution improves the sealing of the electrical conductor with respect to the housing part, as otherwise particularly severe gap formation would occur here.

The electrical conductor extends in the feedthrough through the housing part in a main axial extension. In this context, the term radial refers to the directions perpendicular to the axial main extension, wherein radially surrounding describes a closed circumference. The electrical conductor, which may also be referred to as a conductor rail, may comprise a circular, oval, rectangular or other cross-section. The first, third and fourth sealing sections on the electrical conductor may be referred to as sheath surfaces or sheath sections, which are preferably arranged adjacent to each other in the axial direction, wherein the first sealing section is preferably arranged between the third and fourth sealing sections.

The third and fourth sealing sections between the electrical conductor and the housing part may comprise a lower tightness, so that there may not be sufficient sealing against oil in these sealing sections without this worsening the sealing against oil overall. The third and fourth sealing sections can therefore also be referred to as support sections, since in particular a transfer of mechanical loads between the housing part and the electrical conductor can be implemented via these sections.

In the sense of the invention, an elastomeric foam comprises pores which basically correspond to hollow chambers distributed in the material. Dedicated hollow chambers or cavities can be provided in the elastic material of the sealing body, wherein the elastic material can additionally be an elastomeric foam with pores as small hollow chambers.

In an advantageous embodiment, the elastic material is an elastomer foam with closed pores. In the elastomeric foam with closed pores, a proportion of at least 80% closed pores relative to open pores is further proposed. By this, in particular a high permeation density, especially against oil, can be achieved.

According to a further development, it is proposed that the housing part encloses the electrical conductor in a third and/or fourth sealing section radially surrounding the electrical conductor. This allows the sealing body to be protected against mechanical influences from particles and the transmission of mechanical loads between the electrical conductor and the housing part, so that the sealing body can be protected and kept largely free of mechanical loads.

The third and fourth sealing sections between the electrical conductor and the housing part may comprise a lower tightness, so that there may not be sufficient sealing against oil in these sealing sections without this worsening the sealing against oil overall. The third and fourth sealing sections may therefore also be referred to as support sections, since in particular a transfer of mechanical loads between the housing part and the electrical conductor may take place via these sections.

In a further development, it is proposed that the third and/or fourth sealing section in each case axially adjoins the first sealing section on the electrical conductor. This allows the sealing body to be compressed particularly well, especially if both sealing sections, the third and the fourth sealing section adjoin the sealing body. The sealing body is preferably completely enclosed, so that any evasive movements of the sealing body are prevented and a higher compression is possible. By higher compression of the sealing body, a higher sealing pressure can be achieved over a wide thermal range.

According to a further development, it is proposed that the material of the housing part is a plastic, preferably a thermoplastic. In particular, it is proposed that the housing part is made of a high-melting plastic material, which generally comprises better mechanical and/or thermal properties and can provide a permeation-tight seal to the electrical conductor using the proposed sealing body.

According to a further development, it is proposed that the material of the housing part comprises a higher Young’s modulus than the elastic material of the sealing body. This is advantageous in order to achieve sufficient compression of the sealing body and a corresponding good sealing pressure.

It is further proposed that the electrical conductor comprises a rounded contour at least in the first sealing section. It is further proposed that the electrical conductor comprises a rounded contour in the third and/or fourth sealing section.

This avoids leaks caused by microgaps or micronotches, which cannot be avoided in production, as well as excessive stresses at sharp edges of the electrical conductor to the sealing body or to the housing part. The rounded contour in the cross-section of the electrical conductor at the first sealing section to the sealing body, which may additionally be present in the third and fourth sealing sections, comprises roundings with a radius of at least 0.1 mm, preferably at least 0.4 mm, further preferably at least 0.7 mm.

According to a further development, it is proposed that the electrical conductor and the sealing body comprise a substance-to-substance bond. This can further improve the permeation tightness, in particular with respect to oil and oil gases. However, a substance-to-substance bond at the first sealing section as well as at the second sealing section is not absolutely necessary for a sufficient seal due to the enclosed and compressible sealing body.

In a possible embodiment, for example, three electrical conductors can be guided through the housing part and sealed by means of three separate sealing bodies.

Furthermore, to solve the task, a method for manufacturing an electrical conductor according to any one of claims 1 to 8 is proposed comprising the following steps:
providing an electrical conductor;
first molding, in particular injection molding, of a sealing body to the first sealing section radially surrounding the electrical conductor, which sealing section encloses the electrical conductor, wherein the sealing body is formed of an elastic material with at least one, preferably closed, hollow chamber and/or of an elastomer foam;
second molding, in particular injection molding, of the housing part enclosing the sealing body at the second sealing section.

With the proposed method, a permeation-tight seal of the electrical conductor with respect to a housing part can be produced in a simple manner. Molding or injection molding may include, for example, overmolding. The proposed method for manufacturing can provide a good seal between the electrical conductor and the housing part through which the electrical conductor is passed. This applies in particular to high-melting plastics for the housing part, since the correspondingly higher melting temperature means that a higher temperature is required for the second molding, which increases the gap-forming effect between the sealing body and the housing part.

According to a further development, it is proposed that during the second molding, in particular injection molding, the sealing body is compressed under the molding pressure of the second molding of the housing part.

In this way, it can be achieved that the sealing body is enclosed by the electrical conductor and the housing part in the compressed state, so that a contact pressure is established at the first and second sealing sections, which achieves sufficient tightness and, in particular, prevents gap formation due to shrinkage after the manufacturing process during cooling. By the proposed compression of the elastic material, which is compressible by the at least one closed hollow chamber and/or by the elastomer foam, it is also possible to use high-melting thermoplastics in the second molding for the housing part without insufficient compression of the sealing body after cooling.

It is further proposed that the volume of the sealing body is reduced to at least 97%, for example 96%, preferably to at least 95%, further preferably to at least 90%, during the second molding, in particular injection molding.

According to a further development, it is proposed that during the second molding, in particular injection molding, of the housing part, the electrical conductor is enclosed by the housing part in the third and fourth sections. In this way, it can be achieved, among other things, that the sealing body is completely enclosed by the housing part and the electrical conductor, so that a high compression of the sealing body can be achieved during the second molding.

According to a further development, it is proposed that during the first molding, in particular injection molding, the elastic material is crosslinked to form the sealing body. In this way, a high temperature stability of the sealant can be achieved, which is advantageous, among other things, during the second molding or overmolding, especially in the case of high-melting plastics of the housing part.

Alternatively or in addition to the proposed solution to the problem, an electrical conductor for conducting electrical current through a housing is proposed, wherein a sealing body made of an elastic material is arranged on the electrical conductor, and wherein the sealing body encloses the electrical conductor in a first sealing section radially surrounding the electrical conductor. A housing part is arranged on the electrical conductor, wherein the housing part preferably encloses the electrical conductor in a third and fourth sealing section radially surrounding the electrical conductor. The third and fourth sealing sections are preferably each axially adjacent to the first sealing section on the electrical conductor. The sealing body comprises at least one undercut, wherein the housing part projects into the at least one undercut between the electrical conductor and the sealing body with at least one housing part section, and wherein the sealing body comprises at least one sealing surface which is in contact with the housing section in a radially inwardly directed manner and surroundingly seals.

Appropriate shaping of the sealing body and the housing section, which can each be manufactured by a separate casting process, in particular injection molding, can enable adequate sealing and, in particular, can compensate for gap formation due to different shrinkages after the manufacturing process during cooling. A greater shrinkage of the sealing body compared to the housing part can even be advantageous in this case to allow a greater contact pressure between the sealing body and the housing part section in the area of the undercut. The sealing of the electrical conductor to the housing part thus results from the first circumferential sealing section between the conductor and the sealing body and between the sealing body and the housing part section at a circumferential sealing surface against which the sealing body bears radially outwardly against the housing part section in the region of the undercut. The housing section preferably completely encloses the sealing body together with the electrical conductor. Detachment or gap formation in certain areas between the sealing body and the housing part is not critical for the sealing function with the proposed shape design of this alternative solution.

### BRIEF DESCRIPTION OF THE FIGURES

The invention is explained below by means of preferred embodiments with reference to the accompanying figures. Thereby shows

FIG. 1 shows a detailed view of a cross-sectional view with an electrical conductor, a sealing body and a housing part;

FIG. 2 shows a cross-sectional view of a housing part with an electrical conductor fed through and sealed with a sealing body;

FIG. 3 shows a schematic cross-sectional view of an electrical conductor with a sealing body;

FIG. 4 shows a schematic sectional view of an electrical conductor with a sealing body and a housing part during the injection molding process of the housing part;

FIG. 5 shows a further schematic sectional view of an electrical conductor with a sealing body and a housing part after the injection molding process of the housing part;

FIG. 6 shows a view of a housing part with a fed-through electrical conductor, which is sealed with a sealing body; and

FIG. 7 shows four different shapes of the sealing body.

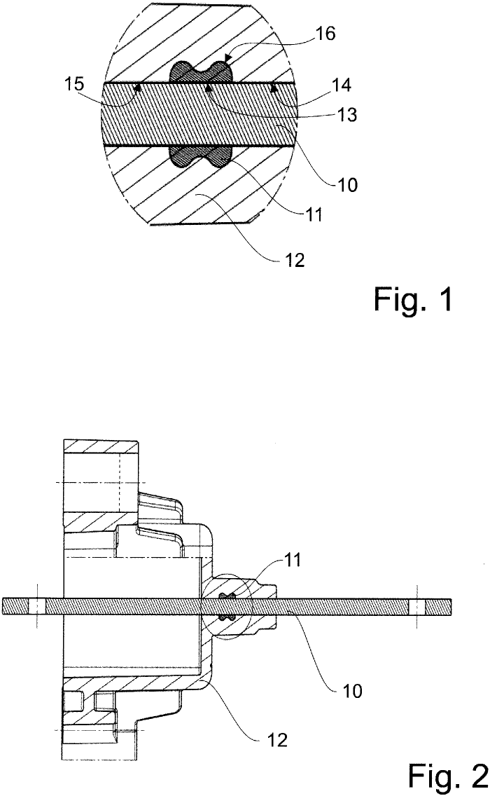

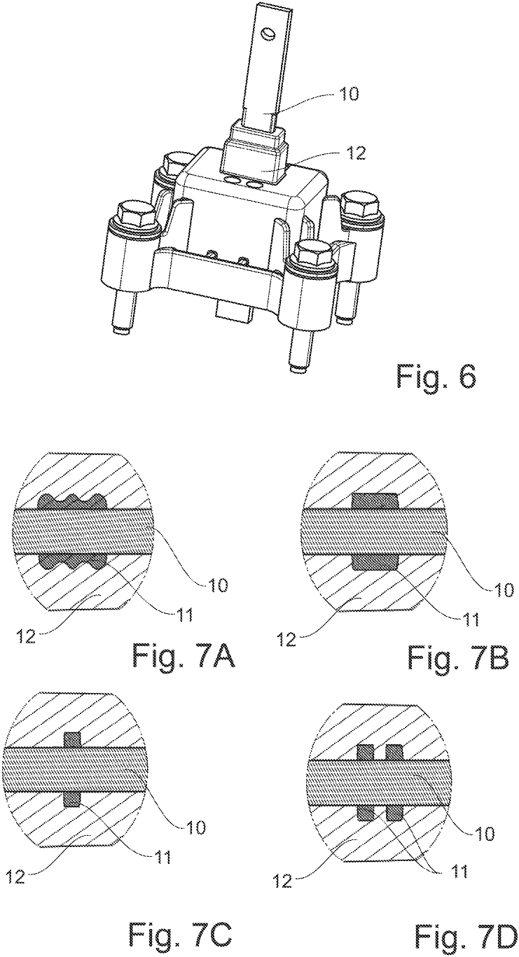

FIG. 1 shows a schematic view of a detail of an electrical conductor 10, which is passed through a housing part 12. The electrical conductor 10 is, for example, a conductor rail made of copper or another metal, and the housing part 12 in this advantageous embodiment example is made of plastic, which in particular can be a thermoplastic. A sealing body 11 is provided, which surrounds the electrical conductor 10 in a first sealing section 13. The first sealing section 13 therefore surrounds the electrical conductor 10 in its cross-section, which may be round or, as in this embodiment, see FIG. 6, rectangular with rounded edges.

The electrical conductor 10 also comprises two circumferential sealing sections, a third sealing section 14 and a fourth sealing section 15 to the housing part 12, which, as can be seen in the illustration of FIG. 1, adjoin the first sealing section 13 on the right and left, or axially. Furthermore, a second sealing section 16 is present between the housing part 12 and the sealing body 11, so that the electrical conductor 10 is sealed in a permeation-tight manner with respect to the housing part 12 via the first and second sealing sections 13, 16. The third and fourth sealing sections 14, 15 are in contact with the electrical conductor 10, which also achieves a sealing effect, but which are not provided for a permeation-tight seal due to the material combination in this example with copper and high-melting thermoplastic for conductor 10 and housing part 12. Among other things, sufficient sealing pressure is not provided for this purpose in the third and fourth sealing sections. Accordingly, it is possible that the third and fourth sealing sections are not sealed, for example, against creeping oil.

For sealing against creeping oil, the sealing body 11 is provided, which is formed of an elastic material, for example an elastomer, which is tight against permeation of oil. In this embodiment, the elastic material is a foamed elastomer which comprises closed pores 18 as hollow chambers 17 distributed in the material in order to exhibit a corresponding permeation tightness despite its property as an elastomer foam. The elastic material of the sealing body 11 preferably comprises a lower modulus of elasticity than the housing part 12. In particular, the modulus of elasticity of the sealing body 11 may be lower if the elastic material is an elastomeric foam.

The sealing body 11 is annular and its inner surface, i.e. the radially inward facing surface, is in contact with the electrical conductor 10. The contact is preferably a sealing pressure. The axial and radially outward-facing surfaces are enclosed by the housing part 12 with the second sealing section 16, as can be seen in the sectional views of FIGS. 1 and 2, so that the sealing body 12 is completely enclosed.

The sealing body 11 is compressible due to its pores 18 in the elastomeric foam, so that it can be inserted in a compressed state between the conductor 10 and the housing part 12 by being completely enclosed or also encased. This means that the sealing body 11 would occupy a larger volume at ambient pressure outside the space between conductor 10 and housing part 12. The compression provides a sealing pressure at the first and second sealing sections 13, 16, which provides a good seal that is tight against creep of oil.

In possible embodiments, the sealing body 11 may further comprise a substance-to-substance bond to the electrical conductor 10, which may be achieved, for example, by an appropriate pretreatment of the surface of the electrical conductor 10, such as roughening and application of adhesion promoters, and overmolding of the sealing body 11. A material bond may further improve the sealing, wherein the pretreatment may require additional effort. The substance-to-substance bond may also further increase the fixation of the sealing body 11 to the electrical conductor 10 during manufacture of the housing part 12.

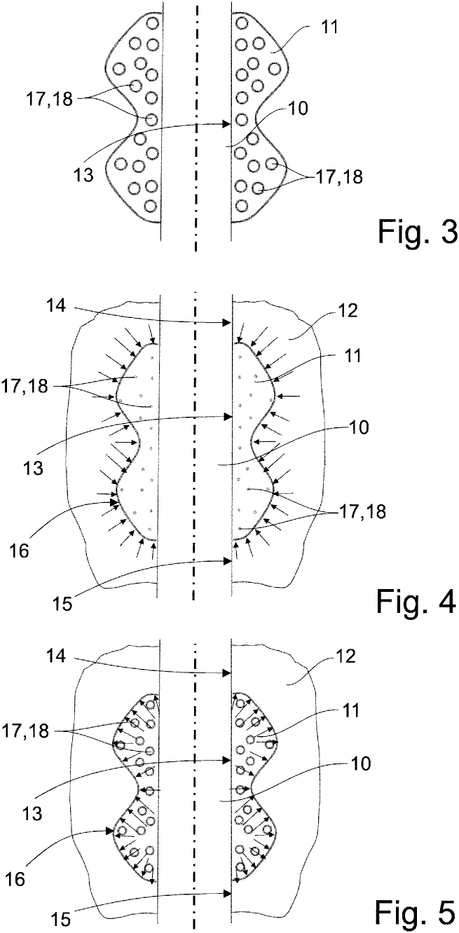

In FIGS. 3, 4 and 5, various steps of a method for manufacturing a corresponding electrical conductor 10 with a housing part 12 arranged thereon, which are sealed against each other by means of a sealing body 11, are shown schematically.

FIG. 3 shows a section of the electrical conductor 10 provided, which has been partially overmolded with an elastomer foam in a first injection molding operation. The elastomer foam is an elastic material, for example rubber, which has been foamed. The corresponding pores 18 in the elastic material are shown schematically as circles. The sealing body 11 surrounds the electrical conductor 10 and rests against it at the first sealing section 13. The elastic material of the sealing body 11 preferably cross-links during the manufacturing process during the first molding.

The next step is illustrated in FIG. 4, in which the electrical conductor 10 with the molded-on sealing body 11 was partially overmolded in a second molding by means of an injection molding process. The second molding is used to produce the housing part 12, which is made of a thermoplastic material. The housing part 12 abuts the electrical conductor 10 with the third and fourth sealing sections 14, 15 and the sealing body 11 with the second sealing section 16. Due to the casting pressure, which is symbolized by arrows in FIG. 4, the sealing body 11 is compressed during the second molding. The compression of the sealing body 11 is illustrated by the reduced pores 18 in the form of smaller circles.

After cooling, if necessary, after curing of the housing part 12 produced during the second molding, the housing part 12 solidifies and shrinks due to cooling to ambient temperature. The sealing body 11, which was also heated during the manufacture of the housing part 12, also shrinks, wherein the coefficient of thermal expansion of the elastic material of the sealing body 11 is generally greater than that of the housing part 12.

However, gap formation, particularly at the second sealing section 16, can be prevented by compression of the elastomeric foam, as illustrated in FIG. 5. The compression of the sealing body 11, which is readily compressible due to the pores 18 or hollow chambers 17, results in a contact pressure corresponding to the symbolic arrows in FIG. 4 on the second sealing section 16 and also on the first sealing section 13. In this way, different coefficients of thermal expansion and shrinkages can be compensated for, so that gap formations can be avoided and at the same time sufficient sealing, for example against air, in particular against creeping oil, can be achieved.

FIG. 6 shows an embodiment of a finished electrical conductor 10 on which a housing part 12 is arranged, which can be mounted, for example, on a housing of an electric motor. The sealing body 11 is well protected against harmful influences and also mechanical loads between the housing part 12 and the electrical conductor 10, so that the sealing body 11 is not visible in the illustration in FIG. 6.

In FIG. 7, various possible shapes of the sealing body 11 are shown, which deviate from the shape of FIG. 1 with two radially circumferential sealing beads. For example, FIG. 7a shows a detail of an embodiment with three radially circumferential sealing beads. In the embodiment of FIG. 7b, the shape of the sealing body 11 comprises a rectangular cross-section in which the axial extension is more than twice the radial material thickness. Deviating from this, the sealing body 11 in the embodiment of FIG. 7c also comprises a rectangular cross-section, wherein the axial extension and the material thickness are substantially the same. FIG. 7d shows a further embodiment in which two sealing bodies 11, corresponding to the embodiment of FIG. 7c, are arranged axially spaced apart on the electrical conductor 10. The shape design of the housing part 12 is in each case adapted to the shape design of the sealing body 11, or can be produced accordingly by the shape design of the sealing body 11 during manufacture.

### EMBODIMENTS

Embodiment 1. Electrical conductor (10) for conducting electrical current through a housing, wherein
a sealing body (11) of an elastic material is arranged on the electrical conductor (10), wherein
the sealing body (11) encloses the electrical conductor (10) in a first sealing section (13) radially surrounding the electrical conductor (10), wherein
a housing part (12) is arranged on the electrical conductor (10), characterized in that
the housing part (12) radially encloses at least a part of the surface of the sealing body (11), which is not in contact with the electrical conductor (10) in the first sealing section (13), in a second sealing section (16), wherein
the elastic material of the sealing body (11) comprises at least one hollow chamber (17) and/or is an elastomer foam.

Embodiment 2. Electrical conductor (10) according to embodiment 1, characterized in that the elastic material is an elastomer foam with closed pores (18).

Embodiment 3. Electrical conductor (10) according to embodiment 1 or 2, characterized in that

the housing part (12) encloses the electrical conductor (10) in a third and/or fourth sealing section (14, 15) radially surrounding the electrical conductor (10).

Embodiment 4. Electrical conductor (10) according to embodiment 3, characterized in that

the third and/or fourth sealing section (14, 15) in each case axially adjoins the first sealing section (13) on the electrical conductor (10).

Embodiment 5. Electrical conductor (10) according to any one of the preceding embodiments, characterized in that the material of the housing part (12) is a plastic, preferably a thermoplastic.

Embodiment 6. Electrical conductor (10) according to any one of the preceding embodiments, in that the material of the housing part (12) comprises a higher modulus of elasticity than the elastic material of the sealing body (11).

Embodiment 7. Electrical conductor (10) according to any one of the preceding embodiments, characterized in that the electrical conductor (10) comprises a rounded contour at least in the first sealing section (13).

Embodiment 8. Electrical conductor (10) according to any one of the preceding embodiments, characterized in that

the electrical conductor (10) and the sealing body (11) comprise a substance-to-substance bond.

Embodiment 9. Method for manufacturing an electrical conductor (10) according to any one of the preceding embodiments, characterized by the following steps:
providing an electrical conductor (10);
first molding, in particular injection molding, of a sealing body (11) to the first sealing section (13) radially surrounding the electrical conductor (10) which encloses the electrical conductor (10), wherein the sealing body (11) is formed of an elastic material with at least one hollow chamber and/or of an elastomer foam;
second molding, in particular injection molding, of the housing part (12) enclosing the sealing body (11) at the second sealing section (16).

Embodiment 10. Method according to embodiment 9, characterized in that during the second molding, in particular injection molding, the sealing body (11) is compressed under the molding pressure of the second molding of the housing part (12).

Embodiment 11. Method according to embodiment 10, characterized in that the volume of the sealing body (11) is reduced to at least 97% during the second molding, in particular injection molding.

Embodiment 12. Method according to any one of embodiments 9 to 11, characterized in that during the second molding, in particular injection molding, of the housing part (12), the electrical conductor (10) is enclosed by the housing part (12) in the third and fourth sections (14, 15).

Embodiment 13. Method according to any one of embodiments 9 to 12, characterized in that during the first molding, in particular injection molding, the elastic material is crosslinked to form the sealing body.

1. An electrical conductor for conducting electrical current through a housing, comprising:
an electrical conductor rail;
a sealing body of an elastic material arranged on the electrical conductor rail,
wherein the sealing body encloses the electrical conductor rail in a first sealing section radially surrounding the electrical conductor rail,
a housing part arranged on the electrical conductor rail,
wherein the housing part radially encloses at least a part of a surface of the sealing body, which is not in contact with the electrical conductor in the first sealing section, in a second sealing section, and
wherein the elastic material of the sealing body comprises at least one hollow chamber and/or is an elastomer foam.

2. The electrical conductor according to claim 1, wherein the elastic material of the sealing body is an elastomer foam with closed pores.

3. The electrical conductor according to claim 1,
wherein the housing part encloses the electrical conductor rail in a third sealing section and/or fourth sealing section radially surrounding the electrical conductor rail.

4. The electrical conductor according to claim 3,
wherein the third sealing section and/or fourth sealing section in each case axially adjoins the first sealing section on the electrical conductor rail.

5. The electrical conductor according to claim 1, wherein the housing part is made of a plastic.

6. The electrical conductor according to claim 1, wherein the housing part is made of a material having a higher modulus of elasticity than the elastic material of the sealing body.

7. The electrical conductor according to claim 1, wherein the electrical conductor rail comprises a rounded contour at least in the first sealing section.

8. The electrical conductor according to claim 1,
wherein the electrical conductor rail and the sealing body comprise a substance-to-substance bond.

9. A method for producing an electrical conductor for conducting electrical current through a housing according to claim 1, comprising:
providing an electrical conductor rail;
first molding of a sealing body to a first sealing section radially surrounding the electrical conductor rail which encloses the electrical conductor rail, wherein the sealing body is formed of an elastic material with at least one hollow chamber and/or of an elastomer foam;
second molding of a housing part enclosing the sealing body at a second sealing section.

10. The method according to claim 9, wherein during the second molding of the housing part, the sealing body is compressed under a molding pressure of the second molding of the housing part.

11. The method according to claim 10, wherein a volume of the sealing body is reduced to at least 97% during the second molding.

12. The method according to claim 9, wherein during the second molding of the housing part, the electrical conductor rail is enclosed by the housing part in a third sealing section and fourth sealing section.

13. The method according to claim 9, wherein during the first molding the elastic material is crosslinked to form the sealing body.

14. The electrical conductor according to claim 5,
wherein the plastic is a thermoplastic.

15. The method according to claim 9,
wherein the first molding is a first injection molding, and
wherein the second molding is a second injection molding.
